(19) United States
(12) Patent Application Publication
(10) Pub. No.: US 2009/0187480 A1
(43) Pub. Date: Jul. 23, 2009

(54) METHOD, SYSTEM, APPARATUS, AND COMPUTER PROGRAM FOR PROVIDING SELECTIVE ADVERTISING TO SUBSCRIBERS

(75) Inventors: Marc R. Bernard, Miramar, FL (US); Douglas A. Atkinson, Ashburn, VA (US); Timothy J. Doiron, Aurora, IL (US)

Correspondence Address: TELLABS OPERATIONS, INC., 1415 West Diehl Road, MS 16, Naperville, IL, 60563, US

(73) Assignee: Tellabs Vienna, Inc., Naperville, IL (US)

(21) Appl. No.: 12/017,429

(22) Filed: Jan. 22, 2008

(51) Int. Cl. G06Q 30/00; G06Q 20/00; G06Q 10/00

(52) U.S. Cl. 705/14; 705/400; 705/40

(57) ABSTRACT

A method, apparatus, system, and computer program for providing selective advertising. The method includes providing an advertisement request specifying that advertising content be provided and automatically providing the advertising content on at least one network service in response to the advertisement request. The advertising content provided is based upon advertising content preferences pre-specified by a subscriber. Also provided is a method for exchanging payments, which includes determining a payment payable to a network service provider from a subscriber and providing the payment to the network service provider from the subscriber. The payment is determined as a cost for access to a selective advertisement service and/or a provisioning of selective advertising.

### BACKGROUND

1. Field

Example aspects of the present invention relate generally to providing network services, and more specifically to an improved method of providing subscribers of network services with advertising content.

2. Description of the Related Art

In the telecommunications industry, network service providers transmit multimedia information, including voice, video, and data information, to subscribers of their networks via a local loop distribution network, one example of which is a passive optical network (PON). A PON can be classified according to the location where optical-electrical conversion of signals occur. For instance, one PON classification is a fiber-to-the-node (FTTN) network, in which optical-to-electrical conversion typically occurs at nodes local to a number of subscribers, and the subscriber equipment connects to the nodes using traditional coaxial or twisted-pair electrical wiring. Similarly, in a fiber-to-the-premises (FTTP) network, which is another classification of PON, conversion typically occurs at a subscriber's premises. Other examples of PONs include fiber-to-the-business (FTTB), fiber-to-the-curb (FTTC) and fiber-to-the-home (FTTH) networks. These types of networks are herein referred to generally as “FTTx networks.”

### SUMMARY

According to an example aspect of the invention, a method, and a network, apparatus, and computer program that operate in accordance with the method, are provided. The method provides selective advertising, and includes providing an advertisement request specifying that advertising content be provided and automatically providing the advertising content on at least one network service in response to the advertisement request. The advertising content provided is based upon advertising content preferences pre-specified by a subscriber.

According to another aspect of the invention, a method for exchanging payments includes determining a payment payable to a network service provider from a subscriber and providing the payment to the network service provider from the subscriber. The payment is determined as a cost for access to a selective advertisement service and/or a provisioning of selective advertising.

Further features and advantages, as well as the structure and operation, of various example embodiments of the present invention are described in detail below with reference to the accompanying drawings.

### BRIEF DESCRIPTION OF THE DRAWINGS

FIG. 1 is a network diagram of an example communication system, which may be suitable for practicing example aspects of the invention.

FIG. 2 is an example data processing architecture.

FIG. 3 shows a flow diagram of a method in accordance with an example aspect of the invention.

FIG. 4 shows a flow diagram of a method in accordance with another example aspect of the invention.

FIG. 5 shows a flow diagram of a method in accordance with still another example aspect of the invention.

FIG. 6 shows an example of a method in accordance with an example aspect of the invention.

FIG. 7 is a logical diagram of a control module, which may be suitable for practicing one or more example embodiments of the invention.

### DETAILED DESCRIPTION

The following description is described in the context of a system having optical network terminals (ONTs) as network elements. However, the invention is not limited for use only with ONTs, but can also be used in conjunction with other network elements such as, for example, optical network units (ONUs), types of remote digital terminals (RDTs), or any other suitable types of nodes operable with a communication network.

Furthermore, as used herein, the terms “advertising content” and “advertisement” may refer to any type of information, message, communication, or other informative notice in which the content thereof is paid for, sponsored, controlled, or otherwise provided by a party. The terms “advertising content” and “advertisement” should not be construed as being limited only to notices for the sale or exchange of goods or services (although it can include them), whether commercial or non-commercial. Also, advertising content or advertisements may exist in any applicable form, including without limitation audio, video, or text information, and/or computer-generated or computer-readable data. Advertising content may be pre-recorded or generated in real time, and may be capable of delivery on one or more network services (e.g., a voice service, a data service, and/or a video service).

Furthermore, as used herein, the term “subscriber” can refer to a service provider, service provider customer, user or purchaser of one or more network services, or any other individual, party, or entity which subscribes to or otherwise receives network services using network equipment. Also, as used herein, the term “subscriber” may also (or alternatively) include one or more communication terminals, or other equipment used by an such individuals, entities, parties, or otherwise, and/or any combination of the foregoing. Also, the term “subscriber terminal” as used herein can refer to a user communication device or customer premises equipment used by an individual, party, or entity that subscribes to or is a customer or recipient of one or more network services.

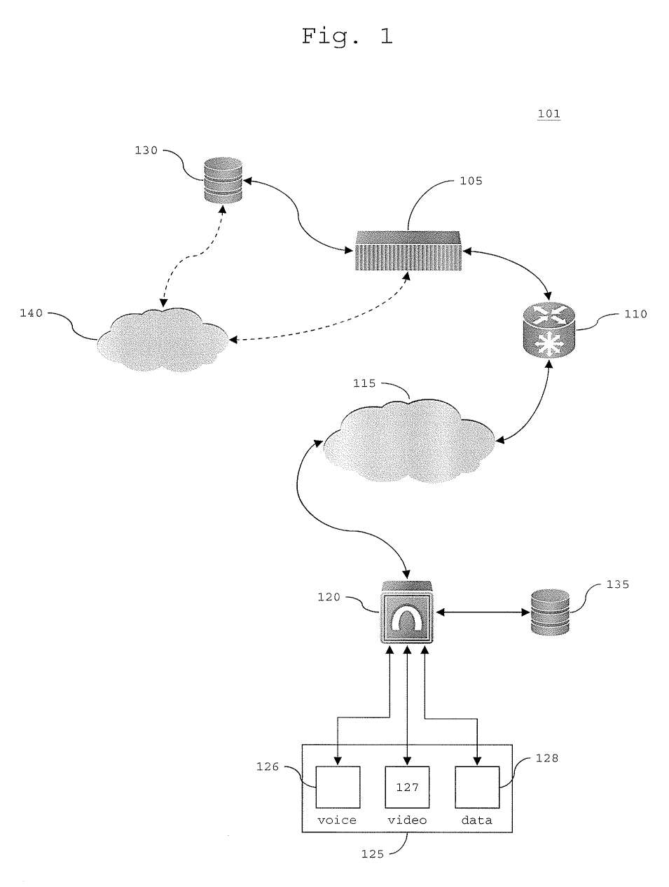

FIG. 1 is a network diagram of an example communication system, such as PON 101, which may be suitable for practicing example aspects of the invention. PON 101 can include a service provider's central office 105, service provider network 115, optical distribution network (ODN) device 110, and ONT 120. Central office 105 can be comprised of, for example (and without limitation), one or more optical line terminals (OLTs) (not shown in the central office 105 of FIG. 1), which can communicatively couple the PON 101 with a wider backbone network (not shown) of external services. Alternatively, one or more OLTs may be located external to central office 105, but can be communicatively coupled to central office 105, in which case PON 101 may also be communicatively coupled to the above-described backbone network by way of those OLTs.

An example application of PON 101 is in a FTTx network, although PON 101 may be used in other applications as well. The optical channels through which communications are provided in the PON 101 can be at bandwidths such as, for example, 155 Mbit/s, 622 Mbit/s, 1.25 Gbit/s, 2.5 Gbit/sec, or any other desired bandwidth. The PON 101 may operate as or in accordance with at least one of the following, such as, for example: an asynchronous transfer mode PON (APON), broadband PON (BPON), Gigabit PON (GPON), Ethernet PON (EPON), 10 Gigabit Ethernet PON (10GEPON), and wavelength division multiplexing PON (WDM-PON). Customer premises equipment (CPE) 125 is communicatively coupled to the service provider network 115 through ONT 120, which in turn is communicatively coupled to central office 105 through ODN device 110. Although FIG. 1 depicts only one CPE connected to one ONT, in practice the PON 101 may be comprised of multiple ONTs, ODNs, and CPEs arranged in any manner suitable to provide communications between the multiple CPEs and central office 105.

Optical signals originating from the central office 105 may be converted at ONT 120 into electrical signals for use by CPE 125. Similarly, electrical signals originating from CPE 125 may be converted into optical signals by ONT 120. ONT 120 can support various network services including, for example, at least one of voice, data, and video. In the case of voice services, ONT 120 may support, for example, digital Voice over Internet Protocol (VoIP), analog public switched telephone network (PSTN) services, and/or other voice services. ONT 120 can provide an analog interface for VoIP services via a subscriber line integrated circuit (SLIC), such that a subscriber can access voice services with a standard analog telephone, and also can provide an interface for broadband digital telephones. In the case of data services, ONT 120 can support data communications via interfaces including, for example, at least one of 10BaseT, 100BaseT, 1000BaseT, MoCA, and HomePNA. In the case of video services, ONT 120 can provide coaxial analog video and/or digital video interfaces supporting video communications services such as, for example, switched digital video (SDV) and/or internet protocol television (IPTV), or any other suitable type of video service.

CPE 125 may include one or more subscriber communication terminals, which can receive and provide communications in the PON 101 by way of ONT 120. CPE 125 can include one or more of, for example, analog PSTN and/or digital broadband telephones 126, video devices 127, and data terminals 128. Also by example, CPE 125 can include (as one or more of components 125, 126, and 127) one or more of a PC, television, cellular radiotelephone, land line telephone, set-top box, pager, portable computer docking node, web-based television unit, personal digital assistant and/or palmtop computer, digital subscriber line (DSL) and/or cable modem, wireless access terminal, or any other type of communication terminal.

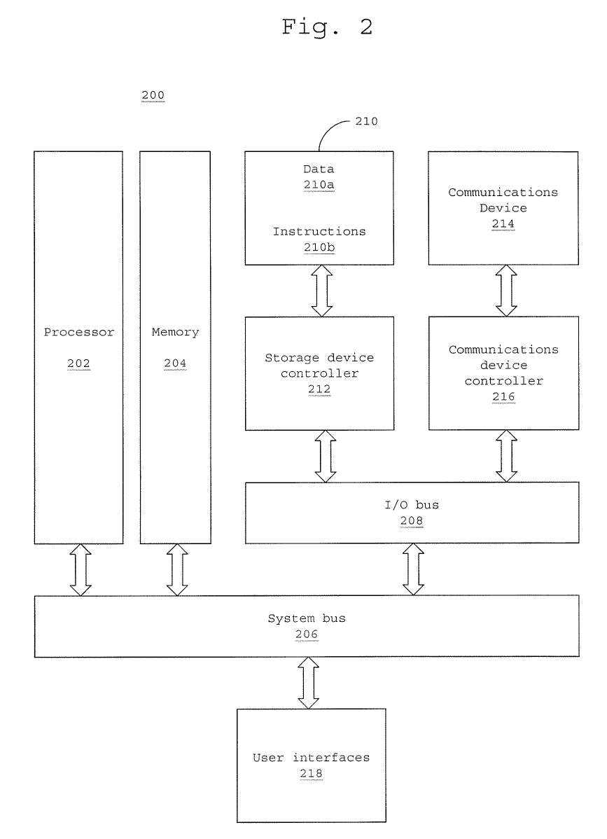

Also shown in FIG. 1 are main advertisement server 130, local advertisement server 135, and advertisement network 140. The advertisement servers and the advertisement network can provide advertising content to other devices within PON 101, as discussed below in connection with FIG. 2. Main advertisement server 130 may be one or more standalone units or devices located on-site at central office 105, or may be located within central office 105, such as in association with or part of an OLT at central office 105. Advertisement network 140 may be, for example, a telecommunications network owned, operated, and/or controlled by a third-party service, such as an advertising company or the like. Advertisement network 140 may or may not be a PON, depending on the applicable network architecture, and may have any other physical network configuration or be a wireless communications network, depending on the applicable network architecture. Main advertisement server 130 and advertisement network 140 may be communicatively coupled to each other, and also to central office 105. Through central office 105, both main advertisement server 130 and advertisement network 140 can provide advertising content to subscriber terminals, e.g., CPE 125, as well as to any other network element or elements located within PON 101 or in other networks in communication therewith.

Similarly, in this illustrated embodiment local advertisement server 135 is shown as being communicatively coupled to ONT 120. Local advertisement server 135 may be communicatively coupled to central office 105, either directly or through network components 120, 115, and 110 as shown. Through central office 105, local advertisement server 135 can provide advertising content to subscriber terminals, e.g., CPE 125, as well as to any other network element or elements located within PON 101 or in other networks in communication therewith. Local advertisement server 135 may be one or more standalone units local to ONT 120 (although it can be remote instead), or may be located within or be a part of ONT 120, although this example is not shown. Local advertisement server 135 may be owned, leased, or otherwise controlled by either the network service provider or a third-party service, such as an advertising company or the like. Through ONT 120, local advertisement server 135 can provide advertising content to subscriber terminals, e.g., CPE 125, as well as to any other network element or elements located within PON 101, or in other networks in communication therewith.

The particular example representation of PON 101 shown in FIG. 1 should not be construed to limit the number or manner of configurations possible for such a communications network. Furthermore, the manner in which advertisement servers 135 and 130 and advertisement network 140 are communicatively coupled within the PON 101 can vary and is not limited only to those shown and described herein.

FIG. 2 is a diagram of an example data processing system which, according to various example embodiments, can form, be incorporated in, or be a part of, for example, ONT 120, CPE 125, main advertisement server 130, local advertisement server 135, and/or an OLT of central office 105 of FIG. 1 or in a remote configuration. Data processing system 200 includes a processor 202 coupled to a memory 204 via a system bus 206. The processor 202 is also coupled to external devices (not shown) via the system bus 206 and an input/output (I/O) bus 208, and at least one user interface 218. The processor 202 may be further coupled to a communications device 214 via a communications device controller 216 coupled to the I/O bus 208. The processor 202 uses the communications device 214 to communicate with a network such as, for example, PON 101 of FIG. 1, and the communications device 214 may have one or more I/O ports. Processor 202 also can include an internal clock (not shown) to keep track of time and periodic time intervals. The user interface 218 may include, for example, at least one of a keyboard, mouse, trackball, touch screen, keypad, or any other suitable user-operable input device, and at least one of a video display, speaker, printer, or any other suitable output device enabling a user to receive outputted information.

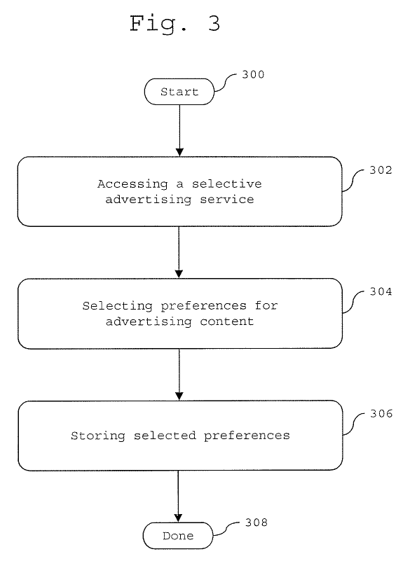

A storage device 210 having a computer-readable medium is coupled to the processor 202 via a storage device controller 212, the I/O bus 208 and the system bus 206. The storage device 210 is used by the processor 202 and storage device controller 212 to read and write data 210a, and to store program instructions 210b. Alternately, program instructions 210b can be stored directly in non-volatile or volatile portions of memory 204. Program instructions 210b can be used to implement, for example, procedures described in connection with FIGS. 3-6.

The storage device 210 can also store various routines and operating systems, such as Microsoft Windows, UNIX, and LINUX, or the like, that can be used by the processor 202 for controlling the operation of system 200. At least one of the operating systems stored in storage device 210 can include the TCP/IP protocol stack for implementing a known method for connecting to the Internet or another network, and can also include web browser software for enabling a user of the system 200 to navigate or otherwise exchange information with the World Wide Web.

In operation, the processor 202 loads the program instructions 210b from the storage device 210 into the memory 204. The processor 202 then executes the loaded program instructions 210b to perform at least part of the example methods described herein.

In the case of, for example, ONT 120, CPE 125, ODN device 110, main advertisement server 130, local advertisement server 135, and/or central office 105, the program instructions 210b can include instructions which, when executed by the processor 202, can cause the device to provide and/or detect advertisement signals on a network service. An advertisement (or advertising) signal can be detected by, for example, monitoring of content provided on a network service (e.g., monitoring for start/stop signals in a downstream channel), monitoring the physical layer of a network service (e.g., packet snooping, sniffing, or mirroring), and/or any other suitable detection procedure. An advertisement signal includes information and/or a notification that advertising content should be requested, generated, and/or provided on one or more network services. For example, an advertisement signal may include information indicating one or more of the following: that an advertisement is to be displayed on a particular video service; that a prerecorded message is to be played via a particular voice service; that a network or Internet advertisement (e.g., a web banner or pop-up) is to be sent via a particular data or video service; and the like. Further examples of advertising signals include, but are not limited to: signals embedded in a network information stream including information specifying that advertising content is to be presented for a predetermined period of time; signals generated by software for including advertising content on a particular data service (e.g., a script monitoring subscriber actions on a web site); signals generated by hardware for including advertising content as a partial or complete replacement for any network service (e.g., a device, such as an ONT, CPE or other network device, can generate advertising signals while booting, rebooting, entering or exiting a power-saving mode, or loss of power); signals generated for including advertising during the loading, deleting or changing of content on a network service (e.g., Internet content loading on a particular data service or the changing of one particular video service to another); signals generated by a subscriber request for advertising content (e.g., a subscriber specifying or requesting to receive advertising content on a network service); or the like.

Advertising signals can be included in any of the network services provided by a network service provider, such as voice, video, or data services. Advertising signals may be inserted or embedded in network service content by any entity which can access network service content such as, for example, a network service provider, an advertising company, or a creator of content traditionally delivered on a network service (e.g., an operator of a particular video service or a webmaster of an Internet web site accessible via a particular data service). For example, such advertising signals can be generated or otherwise provided from any network component, such as, but not limited to, any of those shown in FIG. 1, a backbone network (not shown), or from another component in communication with PON 101.

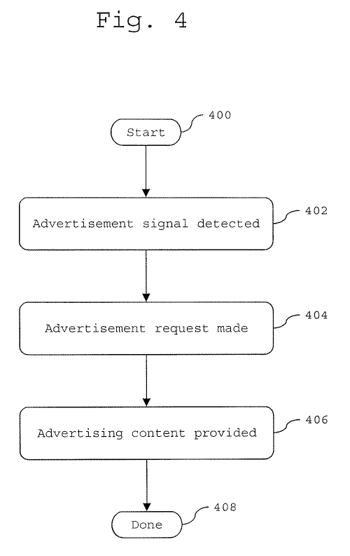

The program instructions 210b also can include instructions which can enable the device 200 to make advertisement requests. An advertisement (or advertising) request is a request that advertising content be provided on one or more network services. Advertising requests can be made in response to the detection of an advertising signal (as described below in connection with block 404 of FIG. 4). Advertising requests also can be made on a periodic (e.g., daily, weekly, or monthly) basis at one or more predetermined times, or based on the occurrence of other predetermined events. If made on a periodic basis, an advertising request can be, for example, an automatic request generated by device 200 for updating advertising content stored on the device, and the advertising request is not made in response to the detection of an advertising signal, although in other embodiments it can be made in response to such a detection and periodically. In circumstances where advertising requests are made at predetermined times and/or upon the occurrence of predetermined events, the request can be generated by a device other than the device receiving the advertising content. For example, CPE 125 can automatically request that updated advertising be provided to ONT 120, or an OLT at central office 105 can automatically request that updated advertising be provided to local advertisement server 135. Advertisement requests, once made, can be forwarded by the requesting device via communications device 214 to another destination or device.

The program instructions 210b can further enable a device to provide, receive, or present advertising content (e.g., the content of an advertisement to be presented to a subscriber or user). Advertising content can be provided on one or more network services or features, including, but not limited to: a video service, a data service, and/or a voice service; an encapsulated port or channel (e.g., a GEM port); a virtual local area network (VLAN); a channel on a data service (e.g., high-speed Internet); a propriety channel; and/or any other suitable network service or feature. Advertising content can be provided on a network service dedicated only to advertising content, or it can provided on a network service on which other content is also provided, e.g., other video, data, and/or voice content. Advertising content can be communicated to a user via at least the user interface 218 or forwarded via communications device 214 to another destination such as, for example, a voice terminal 126, video terminal 127, or data terminal 128, all associated with CPE 125 of FIG. 1. Advertising content, once received by device 200, also can be stored in storage device 210 or memory 204. Advertising content can be provided in response to the receipt of an advertising request (as described below in connection with block 406 of FIG. 4). Advertising content also can be provided on a periodic (e.g., daily, weekly, or monthly) basis at one or more predetermined times, or based on the occurrence of other predetermined events. The provisioning of advertising content on a periodic basis can be, for example, an automatic delivery of advertising content from one device, terminal, or location (e.g., ONT 120, main advertisement server 130, advertisement network 140, or an OLT associated with central office 105) to another device, terminal, or location (e.g., CPE 125, ONT 120, or local advertisement server 135), and the advertising content is not provided in response to an advertisement request, although in other embodiments advertising content can be provided in response to such an advertisement request.

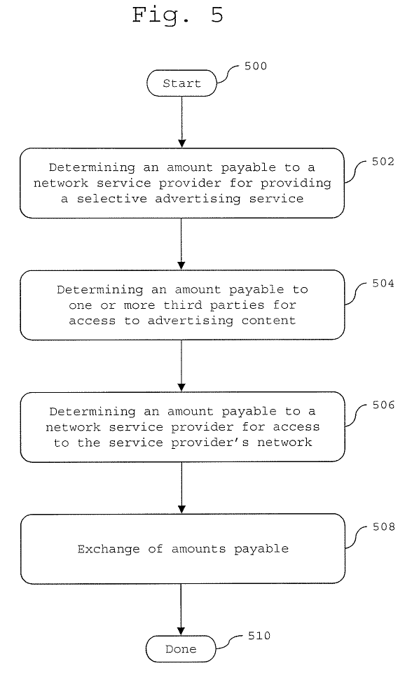

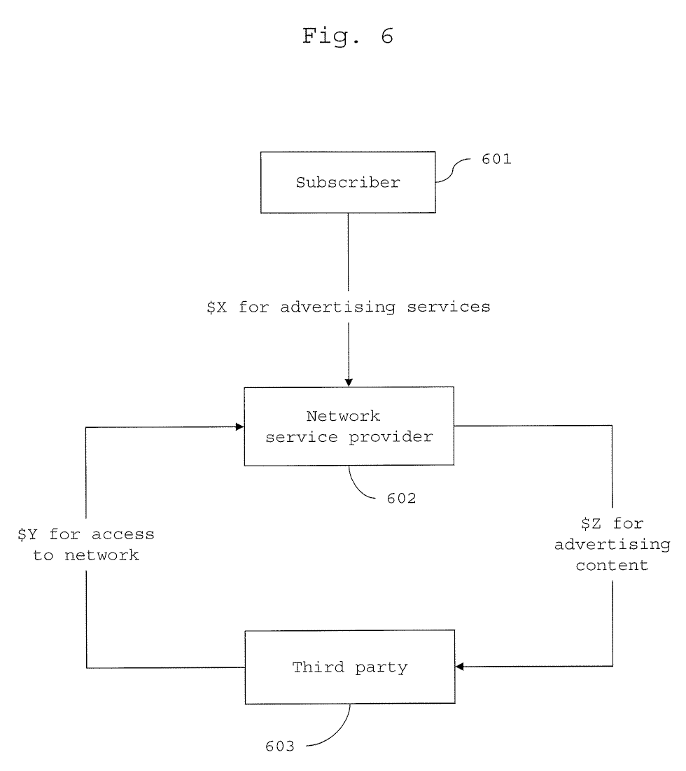

Additionally, the program instructions 210b can include instructions for performing an exchange of payments between subscribers, network service providers, and third-party companies or the like, as described below in connection with FIGS. 5 and 6.

### Providing Selective Advertising to Network Service Subscribers

As FTTx networks generally include services such as video, voice and data, users or subscribers to these services can be presented with advertisements via these network services. For example, a viewer viewing a video service typically sees presented advertisements in addition to scheduled programming content provided on that service. Similarly, a user of a data service having access to a network such as the World Wide Web typically can be presented with advertising banners embedded in web pages, popup windows, and the like.

Users generally are exposed to these and other forms of advertising content whenever they are using subscribed-to network services. However, the effectiveness of the advertising content can be minimal, i.e., users' purchasing behaviors are often unaffected by advertising presented over network services. Many users simply ignore or otherwise disregard advertising content provided over network services due to the high volume of advertising to which they may be exposed, or because the subject matter of the advertisements may not be of interest to them. As a result, third-party advertising companies often seek ways to improve the effectiveness of advertising content provided to network service users.

One procedure advertising companies have used for improving the effectiveness of advertisements is to deliver content based upon a subscriber's geographic location. Advertising content may be tailored based upon, for example, a country, city, zip code, or specific internet service provider (ISP) dedicated to a specific area. While this procedure may prevent delivery of certain clearly inapplicable content, e.g., content not in the subscriber's native language, it cannot allow for advertising to be specifically tailored to an individual user or subscriber. Additionally, even though advertising content may be tailored to have locally-applicable content or themes, the probability still remains very low that the subject matter of any advertisement provided to a subscriber is of particular interest to the subscriber. An improved way to increase the effectiveness of network-provided advertisements therefore can be useful.

FIG. 3 shows a flow diagram of an example method for enabling subscribers of network services to select advertising content. At block 300, the method is commenced. At block 302, a subscriber accesses a selective advertising service via a network service. A selective advertisement service, which also is referred to herein as a “selection service,” can provide a subscriber with the ability to select the kind, type, content, and/or subject matter of advertising content provided in one or more of the subscriber's network services. A selection service can enable a subscriber to specify preferences for any kind, type, subject matter, and/or content of advertisements provided in the subscriber's network services, or can enable a subscriber to specify preferences for only part or a percentage of advertising content. A selection service, when presented to a subscriber, may contain, in whole or in part, a list of topics and/or categories of advertising content, with which the subscriber can interact using, for example, CPE 125 to choose desired advertising content (e.g., advertisements relating to automobiles, food, toys, electronics, household services, etc.). A category or list as presented also can have one or more accompanying selectable options that enable the subscriber to specify the overall desired portion, percentage or amount of total advertising content included in the list or category. A category or list as presented also may have one or more accompanying options that enable a subscriber to select which subscriber terminals or devices, e.g., voice terminal 126, video terminal 127, and data terminal 128, or any other terminal associated with CPE 125 of FIG. 1, should be provided with advertising content from the list or category. For example, a subscriber may select an option to specify that certain categories of advertising content be provided on a particular video service or to particular terminal or network address, and that other categories shall be provided to another video service or to another terminal. Furthermore, a list or category can have one or more accompanying options enabling a subscriber to select advertising content based upon the network content being provided (e.g., to specify that certain categories of advertising content be provided or not be provided on a particular video service, data service, and/or voice service).

Additionally, in an example embodiment of the invention, a list or category may be specific to a business (or other entity) location or otherwise be a business-oriented (or other entity-oriented) category. For example, a category can contain one or options enabling a subscriber to select advertisements specific, to or suitable for display at, a business (e.g., a doctor's office, a restaurant, or any other location where businesses make network services available to their customers or clients). In this manner, a business (or other entity) can ensure that their clients and customers are exposed to specific advertising content that may be in the best interest of, or preferred by, the business (or other entity) owner.

In an example embodiment of the invention, the selection service can be a network service-based selection service, such as a selection service based on or accessed via, for example, a particular data service (e.g., a web-based selection service on a website or an internet-based application), a particular video service (e.g., an interactive television channel), or the like. In this example embodiment, a subscriber can access the network-based selection service using a suitable network communication terminal or device such as, for example, voice terminal 126, video terminal 127, and data terminal 128, any other terminal associated with CPE 125, ONT 120, or local advertisement server 135. The network-based selection service may be provided to subscribers by a network service provider or a third party, such as, for example, an advertising company, advertising monitoring agency, or the like.

Referring again to FIG. 3, at block 304, the subscriber makes one or more selections for specifying preferred advertising content. These selections of advertising content may also be referred to herein as “preferences.” As described above, the preferences can be specified via, for example, a user interface 218 of the device used by the subscriber to access the selection service in block 302.

A subscriber's preferences specified at block 304 can be stored at block 306. A subscriber's preferences of advertising content may be stored at any device, network element, or other network location accessible in a network service provider's network. In an example embodiment of the invention, a subscriber's preferences can be stored locally to the subscriber's network access equipment in devices such as, for example, CPE 125 (e.g., a premises-based PC or server, a set-top box, and/or a network-attached storage device, etc.), ONT 120 (in which case the preferences are provided from CPE 125 to the ONT for storage therein), or local advertisement server 135 (in which case the preferences are provided from CPE 125 to ONT 120, and then to server 135 for storage therein). In another example embodiment of the invention, the subscriber's preferences can be stored at another remote network location such as, for example, central office 105, ODN device 110, main advertisement server 130, service provider network 115, advertisement network 140, or any other suitable storage location (not shown in FIG. 1) of PON 101. If the device, terminal, or network element through which a subscriber accesses a selection service at block 302 is not the same as the device, terminal or network element in which the preferences are stored at block 306, then the preferences can be transmitted to the storing device over a network service such as, for example, a data service, voice service, and/or a video service.

By storing subscriber's preferences at a network-accessible device, terminal, or network location at block 306, when a subscriber subsequently accesses a network service to be provided with content at, for example, CPE 125 by way of the network, the subscriber's preferences can be accessed, read, or otherwise taken into account to determine how the advertising content should be presented, based on the preferences, as described in connection with FIG. 4 below. As such, subscribers can at least partially control the manner in which advertisements are provided in the subscribed-to network services, as will be further described below. At block 308 the method of FIG. 3 is terminated.

FIG. 4 shows a flow diagram of an example method for selectively providing advertisements to subscribers of network services. At block 400, the method is commenced. At block 402, an advertisement signal provided or otherwise generated by a component of the network is detected, as described above in connection with program instructions 210b. In an example embodiment of the invention, detection of an advertisement signal can be performed locally to a subscriber's network access equipment. For example, the detection at block 402 can be made by CPE 125, ONT 120, or local advertisement server 135, all of FIG. 1, based on advertisement signals provided or generated by those same components or signals received by the respective component(s) from one or more other network components. In another example embodiment, the detection of any such advertising signals can be made at a location remote to the subscriber's network access equipment. In this embodiment, detection can occur, for example, at central office 105, ODN device 110, or main advertisement server 130, or within service provider network 115, advertisement network 140, or any other suitable location or device within PON 101.

At block 404, an advertisement request is made in response to the detection of the advertisement signal. An advertisement request is a request that specific advertising content be provided on one or more network services, as described above in connection with the program instructions 210b. An advertisement request made at block 404 can be made by, for example, the same device that detects an advertising signal at block 402. In an example embodiment, the advertisement request is transmitted from the requesting device via a network, e.g., PON 101 in FIG. 1, if the device cannot provide the advertising content corresponding to the request, as described further below in connection with block 406 (thus, the device must request that advertising content be provided by a source other than the detecting device). For example, if a subscriber's ONT (e.g., ONT 120 of FIG. 1) detects an advertisement signal at block 402, but the ONT does not have the capability to provide advertising content in response to the signal, an advertisement request can be transmitted by the ONT via the network to another device having that capability, such as, for example, local advertisement server 135, central office 105, and/or main advertisement server 130, in order to have such network elements provide the advertising content.

In another example embodiment, if the device that made the detection at block 402 has the capability to provide the applicable advertising content, then the request for advertising content is not transmitted externally in response to that detection, but instead is generated at block 404 and processed locally within the detecting device, and, as a result, the advertising content is provided as described below in connection with block 406. Thus, the advertising request need not be transmitted over the network in that example, and the advertisement request simply can be an internally-processed instruction or set of instructions. For example, if a subscriber's ONT is programmed to provide advertising content, in response to an advertising request at block 404 the ONT can provide requested advertising content without a need for transmission of the request to another device of the network, although in other embodiments the request can be so transmitted and also be processed locally within the detecting device.

In yet another embodiment of the invention, an advertisement request can be made at block 404 at a predetermined or periodic time, or upon the occurrence of a predetermined event, rather than in response to the detection of an advertising signal (as described in connection with block 402). In this embodiment, an advertising request made at block 404 can be, for example, an automatic request generated by a device for updating advertising content stored on the device; thus, the advertising request is not made in response to the detection of an advertising signal. In other embodiments, however, the request at block 404 can be made in response to either a detection at block 402, a periodic or predetermined time or event, or both.

In still a further embodiment, in response to block 402 a decision block (not shown) can be entered in which it is determined whether the detecting device has a capability to provide advertising content. If it does not, then the request is transmitted to other devices as described above, whereas if the detecting device does have the capability, the request is processed locally within the device as described above.

In various example embodiments of the invention, there can be circumstances where no advertisement request is generated at block 404. For example, a provider (or creator or operator) of content delivered on a network service (e.g., an operator of a particular video service or channel, a webmaster of an Internet web site accessible via a particular data service, or the like) can include instructions or other information in an advertising signal indicating that associated advertising content should not be provided in accordance with blocks 404 and 406, a described below. A content provider might include these instructions if, for example, the content provider has included its own advertising on the network service (e.g., an advertisement included in video streamed on a particular video service, a pop-up banner included in a data stream on a particular data service, or the like) and the provider does not want its advertising content superceded, i.e., overwritten. In these example embodiments, in response to block 402 a decision block (not shown) can be entered in which it is determined whether the content provider has included its own advertising content within the provided content and does not want the advertising superceded. If it has not, then block 404 is entered as described above, whereas if advertising content has been included by the content provider and should not be superceded, the method terminates (and advertising content provided by the content provider is delivered).

At block 406, advertising content is provided in response to performance of block 404. According to an example aspect of the invention, the advertising content can be provided at block 406 automatically in response to performance of block 404, and, in one example embodiment, it can be provided to a destination (e.g., ONT 120 or CPE 125) without requiring any additional action or event to request such content, such as a request generated by a subscriber or a request generated by an automatic routine stored in a device 210.

In an example embodiment of the invention, advertising content can be provided by an advertisement server. Examples of advertisement servers include main advertisement server 130 and local advertisement server 135, as shown in FIG. 1. Other examples of advertisement servers can include any network service provider or entity device suitably configured or programmed to provide advertising content, e.g., a server (not shown in FIG. 1) located at central office 105 or servers (also not shown in FIG. 1) contained with service provider network 115. (In an example aspect of the invention, the network service provider may own or operate its own advertising server, which may be located at the service provider's central office or at any remote location within its network.) In this example embodiment, the advertisement server receives an advertising request provided at block 404 from the device that made the detection at block 402, by way of the network (e.g., PON 101). In response to receipt of this request, the advertisement server then provides predetermined advertising content and/or advertising content corresponding to the request (block 406).

In an example embodiment of the invention, and as described above, the advertising content can be provided by the same device that made the advertising request at block 404. For example, if the subscriber's ONT (e.g., 120) is programmed or configured to both make advertisement requests and provide advertising content, the ONT then can provide the advertising content in response to the advertising request. In another example embodiment, there may be circumstances when no advertising content is provided in response to an advertising request. Such a circumstance may occur when, for example: the device making the advertising request at block 404 cannot establish communications to send (and/or receive) network communications to (and/or from) the device providing the advertising content at block 406 (e.g., ONT 120 cannot send an advertising request to main advertisement server 130); advertising content cannot be provided on one or more network services (e.g., advertising content provided to ONT 120 cannot be inserted by the ONT into a video, voice, or data stream); and/or any other circumstance where advertising content cannot be provided in response to an advertisement request. In this example, default advertising content, i.e., advertising content that may serve as a substitute or backup to requested advertising content, can be provided at block 406. Default advertising content can be stored locally to the device making the advertising request at block 404 and provided at block 406. For example, if ONT 120 makes an advertising request to main advertisement server 130 but the request is not received by the main advertisement server (e.g., as determined by the ONT after not receiving a reply within a timeout period), then the ONT can provide default advertising content at block 406. Thus, in this example embodiment, the providing of default advertising content at block 406 ensures that a subscriber will be provided with advertising content even if there is a circumstance that might otherwise have prevented advertising content from being provided.

In another example embodiment of the invention, the advertising content can be provided at block 406 by a device (or network element or terminal) other than the device that made the advertising request at block 404. For example, if the subscriber's ONT (e.g., 120) is programmed make advertisement requests but is not programmed to provide advertising content, then at block 404 the ONT can send the advertising request to another device (in this example, such devices may include, but are not limited to, ODN 110, central office 105, main advertisement server 130, local advertisement server 135, and/or CPE 125), which can provide advertising content at block 406, in which case the content is communicated back to the ONT and then to CPE 125. Furthermore, as described above in connection with the default advertising procedure example embodiment, default advertising content also can be provided by a device other than the device requesting advertising content. For example, if a subscriber's ONT requests advertising content from a device (e.g., an OLT) located at central office 105 but the request is not received by the OLT, then the advertising content can be provided at block 406 by a backup (or default) device, such as, for example, local advertisement server 135 or any terminal or device associated with CPE 125. Thus, default advertising content can be provided at block 406 by a device other than the device that requested advertising content at block 404.

In yet another example embodiment of the invention, the advertising content can be provided by a third-party network, such as advertisement network 140 of FIG. 1. In this embodiment of the invention, advertisement requests made at block 404 can be sent to the third-party network from the device that made the detection at block 402, and the network responds by providing the advertising content from one or more elements (e.g., servers) thereof to the requesting device or another predetermined device.

In still another example embodiment of the invention, a third party may provide advertising content in a number of ways including, but not limited to, allowing a service provider to communicatively couple a network operated by the service provider to a network or networks operated by the third party, and selling, leasing, or otherwise providing advertising servers for communicatively coupling to a communications network and/or device(s). Examples of third parties that provide advertising content at block 406 include, for example and without limitation, advertising agencies, businesses, or any other company or entity which sells, leases, controls, or otherwise provides advertising content.

In yet another embodiment of the invention, advertising content can be provided at block 406 at a predetermined or periodic time, or upon the occurrence of a predetermined event, rather than in response to an advertisement request (as described in connection with block 404). In this embodiment, advertising content provided at block 406 can be, for example, an automatic delivery of advertising content to a device, terminal, or network location; thus, the advertising content is not provided in response to a request for advertising content originating from, made by, or otherwise pertaining to the recipient device. In other embodiments, however, the content at block 406 can be provided in response to either a request at block 404, a periodic or predetermined time or event, or both.

The advertising content provided at block 406 can be provided to, for example, ONT 120, local advertisement server 135, or any communications terminal described above in connection with CPE 125 or other network elements of FIG. 1, including but not limited to the device that made the detection at block 402. Advertising content can be provided to multiple terminals or devices, and can also be provided to terminals, network elements, and/or devices owned, operated, possessed, controlled by, or otherwise associated with other subscribers, depending on applicable operating criteria. Advertising content also can be provided to terminals, network elements, and/or devices operated by or otherwise associated with one or more network service providers or third parties, such as, for example, advertising content providers, advertising monitoring agencies or the like. If advertising content is provided in response to an advertisement request transmitted over the network, the advertising content can be provided via the same network, or alternatively can be provided via any other suitable communications network, such as, for example, a wireless cellular network or other type of network.

Examples of advertising content provided at block 406 can include, without limitation, advertising content on a video service (e.g., television commercials, video-based or audio and video-based classified advertisements, real-time product placement), advertising content on a data service (e.g., web banners, pop-up windows, targeted audio or video streams, targeted and/or unsolicited emails), advertising content on a voice service (e.g., pre-recorded or live audio messages), and/or any other advertising content that may be provided on a network service. Subject matter of the advertising content provided at block 406 may be, for examples, the sale or exchange of goods or services, although the subject matter is not limited to this and may include, for example, public service advertising or other non-commercial advertising. Also, advertising content provided at block 406 may exist in any applicable form, including without limitation audio, video, or text information, and/or computer-generated or computer-readable data, and the advertising content may be pre-recorded or generated in real time.

In an example embodiment of the invention, advertising content provided at block 406 can be based upon a subscriber's preferences, specified as described in connection with block 304 of FIG. 3. In this example embodiment, the subscriber's preferences may have been previously selected and stored. If the preferences are stored by the device (or terminal or network element) providing advertising content at block 406, then the preferences can be retrieved by the device accessing or reading the preferences from the device's data storage, such as, for example, storage device 210 or memory 204. Likewise, if the preferences are stored by a device (or a terminal or network element) other than the one providing advertising content at block 406, then the preferences can be retrieved by the preference-storing device and either be provided to the advertising content-providing device, which provides the content based on the specified preferences, or the retrieved preferences can be used by the preference-storing device which, upon receiving the advertising content from the content-providing device, outputs the content to a user based on the retrieved preferences. Thus, when advertising content is provided, a subscriber's preferences can be used to fully or partially control the advertising content provided on the network service. At block 408 the method terminates.

### Revenue Generation by Selective Advertising

Network service providers typically seek to increase their revenues. Although one way to increase revenues is to increase the subscription fees charged to subscribers, service providers generally cannot increase these fees beyond the market price for network services, lest they risk losing subscribers to other service providers charging lower subscription fees. Another way service providers may attempt to increase revenue is to bundle certain services together, offering the bundle to subscribers at a total price lower than the sum of the individual services. Although bundling of network services can be effective, particularly when the individual network services have very low marginal costs to the service providers, as subscribers become more technologically savvy they may opt for non-bundled services. As an example, a subscriber who views digital video content via a data service may choose to cancel the video service from their bundle, or choose to purchase only the data service, forgoing a higher-priced bundle altogether. Also, if bundling is common among network service providers, no individual service provider is afforded the benefit of bundling vis-à-vis other service providers.

Thus, to further increase revenue without employing the foregoing techniques, network service providers can introduce advertising content into their network services. In doing so, a service provider can charge a fee to a third party for the rights, access, or ability to provide advertising content on one or more of the service provider's network services. However, in general there is a lack of effectiveness of advertising content provided to network service subscribers, as previously described; this lack of effectiveness can limit the fees that service providers can charge third-party companies, as the advertising companies may not be willing to pay high fees to provide advertising content that, as an end result, often fails to generate both significant business from the network service subscribers and increased revenue to the advertising companies.

FIG. 5 shows a flow diagram of an example method of exchanging payments between network service providers, subscribers, and/or third-party entities (e.g., companies), while FIG. 6 shows an example embodiment of the method diagramed by FIG. 5. In FIG. 6, a network service provider 602 provides network service to a subscriber 601, and a third party 603 provides a selective advertising service and/or advertising content to the service provider 602 (and ultimately the subscriber).

At block 500 of FIG. 5, the method is commenced. A determination is made at block 502 of an amount payable to a network service provider, as will be described below. In an example embodiment of the invention, the amount payable at block 502 can be payable by a subscriber of one or more of the network service provider's services, and can correspond to a value or an amount the subscriber pays a network service provider for access to a selective advertisement service (as previously described in connection with FIG. 3) and/or provisioning by the network service provider of selective advertising (as previously described in connection with FIG. 4), which are collectively referred to hereinafter as “advertising products.” With reference to FIG. 6, the amount the subscriber pays at block 502 for an advertising product is represented by $X. The amount the subscriber pays the network service provider for advertising products can be in addition to any other amounts the subscriber pays the service provider including, for example, network service subscription fees, network service connection fees, and usage fees, and the like. The amount payable by the subscriber at block 502 can be computed on a periodic (e.g., monthly or annual) basis, and/or on a per-advertisement basis, or on any other suitable basis. The amount payable at block 502 also can be zero (or a small percentage of the overall subscription fees charged to the subscriber) because by improving the subscriber's interest in the advertising content on the subscribed-to network services, the service provider can pass its cost of providing the advertising products on to third parties, as described below in connection with block 504.

In an example embodiment of the invention, the value or amount paid at block 502 by a subscriber to a network service provider for provisioning of selective advertising is variable. In this example embodiment, the amount paid varies based upon the amount of advertising content provided. One circumstance of a variable payment at block 502 could be when, for example, a network service provider charges subscribers on a per advertisement basis. In this circumstance, an increased amount of selective advertising content received by a subscriber could result in a higher amount paid by the subscriber at block 502. Another circumstance of a variable payment could be when, for example, a network service provider wishes to encourage subscribers to view advertising. In this circumstance, the more selective advertising content received by a subscriber, an increased amount of selective advertising content received by a subscriber could result in a lower amount paid by the subscriber.

At block 504, a determination is made of an amount payable by a third party to a network service provider. The amount payable in this block corresponds to an amount the third party pays for access to the service provider's network. With reference to FIG. 6, this amount is represented by $Y. The third party may pay for access to the service provider's network in order to, for example, receive advertisement requests, provide one or more selective advertising services, provide one or more advertisement servers, and/or provide advertising content. A service provider's network may be, for example, PON 101 of FIG. 1, any kind of FTTx network, or any other suitable communications network. The third party may be any company, party, or entity which sells, leases, controls, or otherwise provides advertising content, selective advertising services, and/or advertisement servers. As described above in connection with block 502, because subscribers who pay for advertising products may have more interest in the advertising content provided on their network services (and thus generate higher advertising revenue for the third party), the third party may be financially motivated to pay for access to the service provider's network, in which case the network service provider can pass the cost of the advertising products on to the third party.

At block 506, a determination is made of an amount payable by a network service provider to the third patty. The amount payable in this block corresponds to an amount the network service provider may pay to the third party for advertising content, advertisement servers, and/or selective advertising services provided by that party. With reference to FIG. 6, this amount is represented by $Z.

At block 508 amounts payable are exchanged, as represented by FIG. 6. The amounts exchanged between the subscriber, the network service provider, and third parties are based upon the amounts determined at blocks 502, 504, and 506 ($X, $Y, and $Z of FIG. 6). The individual amounts payable can be positive, zero, or even negative amounts. For example, a network service provider can offer a subscriber a monthly rebate for participating in its selective advertisement service. In this example, the amount payable at block 502 can be the monthly rebate amount, in this case a negative amount (e.g., a credit) because the amount could be paid from the network service provider to the subscriber. As another example, if the service provider can generate revenues through fees paid by subscribers wishing to enroll in selective advertisement services, the service provider could charge a fee to a third party for enabling that entity's access to the service provider's network. In this example, the amount payable at block 504 would be zero. As yet another example, if the third party provides advertising content that the network service provider wishes to be made available to its subscribers, the network service provider can pay the third party a monthly amount (or an amount in another basis) in order to have the third party provide advertising content to the network service provider's subscribers. In this example, the amount payable at block 504 would be the monthly (or other) amount.

The amounts payable, as described in connection with blocks 502, 504, and 506, may be generally thought of as market-based, i.e., the specific amounts can be determined following negotiations between subscribers (and third parties) and network service providers.

It should be understood that the example embodiments shown in FIGS. 5 and 6 are not limited to employing a single network service provider, a single subscriber, and a single third party, and can include any number of service providers, subscribers, and third parties. Furthermore, the service providers and third parties can provide services and employ networks similar to or different from the networks and services described above with reference to FIGS. 1-4.

In an example embodiment of the invention, the method of FIG. 5 can be effected, at least in part, automatically. For example, the method can be specified by instructions 210b stored in one or more components of a network (such as PON 101), and the procedures of FIG. 6 can be effected through communications between those components.

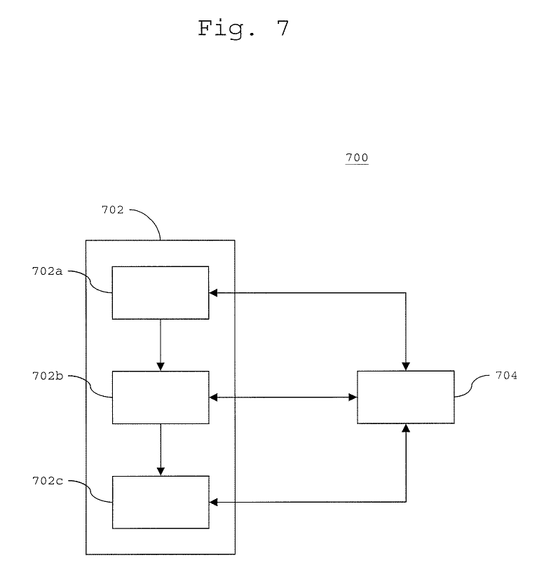

FIG. 7 illustrates a logical diagram 700 of the modules such as, for example, application-specific integrated circuits (ASICs) or field-programmable gate arrays (FPGAs), which could be used as or in association with network elements, e.g., ONT 120, ODN device 110, CPE 125, local advertisement server 135, main advertisement server 130, and any OLT associated with central office 105 of FIG. 1, in accordance with one or more example embodiments of the invention. Logical diagram 700 includes a control module 702 for providing, detecting, and/or processing advertisement signals, as well as requesting and accessing advertisements, and a communication module 704 for directing information between sub-modules of detection module 702, as well as for sending data to and receiving data from other network elements and/or circuit devices.

The detection module 702 includes: a sub-module 702a that detects advertising signals; a sub-module 702b arranged to make advertisement requests based upon processed advertising signals, or provide advertising signals; and a sub-module 702c that provides advertising content in response to advertisement requests. Sub-module 702c can also be arranged to provide advertising content based upon specified preferences.

The communication module 704 can send streams of network content to sub-module 702a for the detection of advertising signals therein, and can further receive advertising signal detections from sub-module 702a. The communication module 704 can also send an advertising signal detection to sub-module 702b in order for sub-module 702b to generate an advertisement request, and can further receive an advertisement request from sub-module 702b. The communication module 704 can further send advertisement requests (as well as subscriber preferences) to sub-module 702c in order for advertising content to be provided, and can further receive provided advertising content from sub-module 702c.

By virtue of the example embodiments described herein, network service subscribers can be provided with selective advertising. By providing subscribers with selective advertising, network service providers and third-party companies can improve attempts to increase their revenues. Furthermore, network service subscribers can be provided with advertising content applicable to goods and services in which they may be interested.

In the foregoing description, example aspects of the present invention are described with reference to specific example embodiments. Despite these specific embodiments, many additional modifications and variations would be apparent to those skilled in the art. Thus, it is to be understood that example embodiments of the invention may be practiced in a manner otherwise than as specifically described. For example, although one or more example embodiments of the invention may have been described in the context of advertisements and advertising content, it should be understood that the invention is not so limited, and that in practice the example embodiments may include or incorporate any other type of content. Accordingly, the specification is to be regarded in an illustrative rather than restrictive fashion. It will be evident that modifications and changes may be made thereto without departing from the broader spirit and scope.

Similarly, it should be understood that the figures are presented solely for example purposes. The architecture of the example embodiments presented herein is sufficiently flexible and configurable such that it may be practiced (and navigated) in ways other than that shown in the accompanying figures.

Software embodiments of the example embodiments presented herein may be provided as a computer program product, or software, that may include an article of manufacture on a machine-accessible, machine-readable, or computer-readable medium having instructions. The instructions on the machine-accessible, machine-readable, or computer-readable medium may be used to program a computer system or other electronic device. The machine-readable or computer-readable medium may include, but is not limited to, floppy diskettes, optical disks, CD-ROMs, and magneto-optical disks or other type of media suitable for storing or transmitting electronic instructions. The techniques described herein are not limited to any particular software configuration. They may find applicability in any computing or processing environment. As used herein, the terms “machine-accessible,”“machine-readable,” or “computer readable” shall include any medium capable of storing, encoding, or transmitting an instruction or sequence of instructions for execution by the machine such that the machine performs any one or more of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

Furthermore, the purpose of the foregoing abstract is to enable the U.S. Patent and Trademark Office, the general public, and scientists, engineers, and practitioners in the art who are unfamiliar with patent or legal terms or phrases, to quickly determine from a cursory inspection the nature and essence of the technical disclosure of the application. The abstract is not intended to limit the scope of the present invention in any way. It is also to be understood that the processes recited in the claims need not be performed in the order presented.

What is claimed is:

1. A method for providing selective advertising, the method comprising:
providing an advertisement request specifying that advertising content be provided; and
automatically providing the advertising content on at least one network service in response to the advertisement request,
wherein the advertising content provided is based upon advertising content preferences pre-specified by a subscriber.

2. The method of claim 1, wherein the advertisement request is provided by an optical network terminal.

3. The method of claim 2, wherein the advertising content is provided by the optical network terminal.

4. The method of claim 1, wherein the advertising content is provided by an advertisement server.

5. The method of claim 1, wherein the subscriber specifies the advertising content preferences using a selective advertising service.

6. The method of claim 1, wherein the advertisement request is provided in response to one of a predetermined time and a predetermined event.

7. The method of claim 1, the method further comprising:
detecting an advertisement signal.

8. The method of claim 6, wherein the advertisement signal is detected at a first location and the advertisement request is made at a second location.

9. A communications system for providing selective advertising, the communications system comprising:
at least one communication terminal; and
at least one network element communicatively coupled to the at least one communication terminal,
wherein at least one of the at least one communication terminal and the at least one network element is arranged to provide an advertisement request specifying that advertising content be provided, at least one of the at least one communication terminal and the at least one network element is arranged to automatically provide advertising content on at least one network service in response to the advertisement request, and the advertising content provided is based upon advertising content preferences pre-specified by a subscriber.

10. The communications system of claim 9, wherein the at least one network element comprises an optical network terminal.

11. The communications system of claim 9, wherein the at least one network element comprises an advertisement server.

12. The communications system of claim 9, wherein the subscriber specifies the advertising content preferences using a selective advertising service.

13. The communications system of claim 9, wherein the advertisement request is provided in response to one of a predetermined time and a predetermined event.

14. The communications system of claim 9, wherein at least one of the at least one communication terminal and the at least one network element is further arranged to detect an advertisement signal.

15. The communications system of claim 14, wherein the advertisement signal is detected at a first location and the advertisement request is made at a second location.

16. A network element operating in a communications network, the element comprising:
a communications interface coupled to a network providing a plurality of communication services;
a storage device arranged to store program instructions; and
a processor coupled to the communications interface and the storage device, and operating under the control of the program instructions to communicate with the network through the communications interface,
wherein the program instructions include instructions for providing an advertisement request specifying that advertising content be provided and for automatically providing advertising content on at least one network service in response to the advertisement request, and wherein the advertising content provided is based upon advertising content preferences pre-specified by a subscriber.

17. The network element of claim 16, wherein the network element is an optical network terminal.

18. The network element of claim 16, wherein the network element is an advertisement server.

19. The network element of claim 16, wherein the subscriber specifies the advertising preferences using a selective advertising service.

20. The network element of claim 16, wherein the advertisement request is provided in response to one a predetermined time and a predetermined event.

21. The network element of claim 16, wherein the program instructions further include instructions for detecting an advertisement signal.

22. A computer program embodied in a computer-readable storage medium, the program having instructions which, when executed by a computer, cause the computer to perform a method for providing selective advertising, the method comprising:
providing an advertisement request specifying that advertising content be provided; and
automatically providing the advertising content on at least one network service in response to the advertisement request,
wherein the advertising content provided is based upon advertising content preferences pre-specified by a subscriber.

23. The computer program of claim 22, wherein the subscriber specifies the advertising content preferences using a selective advertising service.

24. The computer program of claim 22, wherein the advertisement request is provided in response to one of a predetermined time and a predetermined event.

25. The computer program of claim 22, the computer program further comprising:
detecting an advertisement signal.

26. A method for exchanging payments, the method comprising:
determining a first payment payable to at least one of a network service provider and a third party from a subscriber; and
providing the first payment to the network service provider from the subscriber,
wherein the first payment is determined as a cost for at least one of access to a selective advertisement service and a provisioning of selective advertising.

27. The method of claim 26, the method further comprising:
determining a second payment payable to a network service provider from at least one third party; and
providing the second payment to the network service provider from the at least one third party,
wherein the second payment is determined as a cost for access by the at least one third party to a network operated by the network service provider

28. The method of claim 27, the method further comprising:
determining a third payment payable to the at least one third party from the network service provider; and
providing the third payment to the at least one third party from the network service provider,
wherein the third payment is determined as a cost for at least one of advertising content, an advertisement server, and a selective advertising service provided by the at least one third party.

29. The method of claim 26, wherein the first payment is at least partially based on an amount of advertising content received by the subscriber.
